(19) United States
(12) Patent Application Publication
(10) Pub. No.: US 2005/0046880 A1
(43) Pub. Date: Mar. 3, 2005

(54) Image forming device and image forming system

(75) Inventors: Toshifumi Asai, Osaka (JP); Hiroki Saitoh, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: Kyocera Mita Corporation, Osaka (JP)

(21) Appl. No.: 10/927,055

(22) Filed: Aug. 27, 2004

(30) Foreign Application Priority Data
Aug. 27, 2003 (JP) JP2003-303538
Aug. 27, 2003 (JP) JP2003-303537

(51) Int. Cl. G03G 15/00; G06F 15/00

(52) U.S. Cl. 358/1.6; 358/402

(57) ABSTRACT

A so-called open image forming system is disclosed that reduces the burden on the user and the system administrator, and permits anyone to use the system and not just users whose use rights have been defined. The image forming system includes printing devices that form images on paper based upon image information, a plurality of terminal devices that are connected to the printing devices via a network and which can transmit an e-mail containing image information to the network, and a server that sends e-mails in response to receiving an e-mail containing image information and that will transmit a predetermined password that identifies the image information to a data transmission terminal device that is one of the plurality of terminal devices.

### BACKGROUND OF THE INVENTION

1. Field of the Invention

The present invention relates to an image forming device such as, for example, a copy machine, a facsimile machine, and a printer, or a so-called multi-function device that possesses these functions, and an image forming system in which image forming devices and terminal devices and the like are connected together via a network.

2. Background Information

A conventional image forming system is known in which, for example, a plurality of personal computers (hereinafter referred to as PCs) form a network with a plurality of image forming devices such as printers and the like. This image forming system can print documents, drawings, and the like by transmitting a print command and information on the documents, drawings, and the like from one of the PCs to one of the image forming devices. Here, the aforementioned network is one having either wired or wireless connections, and may also use the WWW (World Wide Web).

This type of image forming system can be used, for example, by transmitting image data from a PC or the like being used wile out of the office to an image forming device installed in a public location such as a convenience store, executing printing at that location, and then obtaining the printed matter (see, for example, Japanese Unexamined Patent Publication Nos. 2001-290620, 2000-242444, 2000-339237, 2001-293911, and 2001-249958). In this situation, it is well known to use e-mail in order to transmit this image data.

However, the conventional image forming system has the following problems. With a system that uses e-mail to execute image formation as described above, such as the aforementioned Patent Reference 1 for example, there will be a need to install specialized software into a server or the like that performs integrated management of the system, or into a terminal used by a user and the image forming device. In particular, there will be a need to pre-register users in the server or the like in order to identify the person who has sent the e-mail. This is because by correctly identifying the person who sent the e-mail, one can identify the image data transmitted by the user and correctly collect the fee for the image formation.

However, the task of registration or installation will take a considerable amount of time, and there will be a considerable burden placed both on the user and the system administrator. In addition, due to the aforementioned configuration, persons who can use this system will be limited to only those who have completed the registration process, and thus the complexity of requiring the registration process and the like will effectively place a burden on the user, as well as be a hindrance to the expansion of the market for this system.

In addition, when a registration process is required, not only will there will be a risk of registered user data being disclosed or copied, and thus there may be problems with protecting user privacy, but there may also be problems with correctly performing user identification and fee collection. Thus, an unrelated user may be billed for printing fees that they did not incur. If countermeasures such as frequently changing registered user data are taken in order to avoid this situation, it is thought that the appropriate effects can be obtained. However, this will increase the time needed for registration and the like, and will not be a complete solution to this problem, In addition, if the fees for the aforementioned image formation are set so as to take into account the risk noted above (i.e., setting the fees to include a fee for managing registered data), this will naturally result in an increase in the overall cost of image formation, will have an undesirable effect on the system administrator, and of course create an undesirable situation for the user.

In addition, for a user out of the office, knowing which of the printing devices scattered about a wide area is the printing device which will actually execute the printing is of utmost importance. In other words, even if a user that is out of the office transmits an e-mail containing image information by means of a PC, and wants that image data to be printed, it will be almost meaningless if the printing device that is to perform this printing is located extremely far away from the user's present location. Furthermore, the problem described above is even more acute when, for example, one user from amongst a plurality of users that make up a group wants the other members of the group to have printed material based upon certain image information. This is because if the other users are generally spread out in various locations, and the printing devices for each of the other users cannot be identified, the aforementioned object (i.e., getting shared printed material into the hands of the members of the group) cannot be achieved.

### SUMMARY OF THE INVENTION

It is therefore an object of the present invention to provide a so-called open image forming system that reduces the burden on the user and the system administrator, and permits anyone to use the system and not just users whose use rights have been defined. In addition, the present invention also provides an image forming device that is suitable to form a portion of the image forming system.

In addition, another object of the present invention is to provide an image forming system that reduces the burden on the user and the system administrator, permits anyone to use the system and not just users whose use rights have been defined, and which can become a highly convenient printing tool that allows a group that is made up of users who are generally spread out in various locations to obtain shared printed material.

In order to achieve these objects, an image forming system according to a first embodiment of the present invention includes printing devices that form images on paper based upon image data, a plurality of terminal devices that are connected to the printing devices via connection means and can transmit e-mail containing image information to the connection means, and an administration terminal device that, in response to receiving an e-mail containing image information via the connection means, will transmit via the connection means a predetermined password that identifies the image information to a data transmission terminal device that is one of the plurality of terminal devices that send e-mails.

If the image forming system of the first embodiment of the present invention is used, the image forming devices that form a portion thereof can form images on paper based upon image data. Here, “image data” is formed based upon “image information”, but the “image information” is information that is needed in order to form, for example, images on an original document read from a scanner in the image forming device, images formed with a user terminal such as a PC or the like connected to the image forming devices, or other types of images. In the first embodiment of the present invention, the terminal devices can be configured so as to be capable of transmitting e-mail containing image information, and can receive image information contained in e-mail or image data formed based upon this image information, and thus a user of one of the terminal devices can, for example, execute image formation while out of the office by exchanging data via e-mail, and obtain documents that are made up of these images. Note in the first embodiment of the present invention, the word “image” is defined to include all possible images such as text, drawings and the like.

In the first embodiment of the present invention, the administration terminal device (hereinafter referred to as the “server”) is connected to the connection means, and will both receive an e-mail containing image information sent from the data transmission terminal device, and transmit a predetermined password that identifies the image information to the data transmission terminal device that sent the e-mail. When viewed from the perspective of a user of the data transmission terminal device, if the user transits e-mail containing image information to the server, a password will be received by the user as a response to the e-mail. Thus, according to the present invention, because a password will be sent as a response to the user who sent the e-mail, the user who sent the e-mail can be appropriately identified.

Therefore, to the extent that passwords which identify different image information are issued, one user from amongst a plurality of users can identify the image information or image data belonging to him or her by employing the password that he or she received. By transmitting the password not only from the server to the user, but also, for example, to a specific image forming device, the user can use the password as a so-called key for executing image formation of the image information or image data belonging to the user that is in the image forming device.

When this is done, image formation can be executed that employs the image for devices that form a part of the image forming system, without performing a registration process in the server or image forming device as disclosed in the prior art.

An image forming system according to a second embodiment of the present invention includes first to n-th image forming devices (n is a positive integer) that form images on paper based upon image data and to which each are assigned an e mail address selected from first to n-th e-mail addresses, a plurality of terminal devices that are connected to the image forming devices via a connection means and which can transmit e-mail containing image information to the connection means, and an administration terminal device that will in response to the receipt of an e-mail containing image information via the connection means, transmit via the connection means a predetermined first password that serves to identify the image information to at least one of a data transmission terminal device that sent the e-mail and that is one of the plurality of terminal devices and one or more terminal devices that are selected via the e-mail by the user of the data transmission terminal device, The administration terminal device includes identification means that identifies, from amongst the 1st to n-th image forming devices, an m-th image forming device (where m is a positive integer, and 1≦m≦n) that will execute image formation based upon the image information, the identification based upon the content of e-mail containing the first password transmitted from a print request terminal device that is used by a user request printing and is one of the terminal devices that received the transmission of the first password, and transmission means that transmits to the m-th image forming device the image data formed based upon the image information identified by the first passwords and a predetermined second password that identifies the image data, and transmits the second password to the print request terminal device.

If the image forming system according to the second embodiment of the present invention is used, the image forming devices that form a portion thereof can form images on paper based upon image data. Here, “image data” is formed based upon “image information”, but the “image information” is information that is needed in order to form, for example, images on an original document read from a scanner in the image forming device, images formed with a use terminal such as a PC or the like connected to the image forming devices, or other types of images. In the second embodiment of the present invention, the terminal devices are configured so as to be capable of transmitting e-mail containing image information, and can receive image information contained in e-mail or image data formed based upon this image information, and thus a user of the terminal device can, for example, execute image formation while out of the office by exchanging data via e-mail, and obtain documents that are made up of these images. Note that in the second embodiment of the present invention, the word “image” is defined to include all possible images such as text, drawings and the like.

In the second embodiment of the present invention, the administration terminal device (hereinafter referred to as the “server”) is connected to the connection means, and will both receive e-mail containing image information sent from the terminal devices, and transmit a predetermined first password that identifies the image information to at least one of the data transmission terminal that sent the e-mail and the terminal device(s) selected by the user of the data transmission terminal device. For example, if one assumes that each of the plurality of terminal devices are labeled as first, second,. . ., k-th, the first terminal device corresponds to the data transmission terminal device, and the user of the first terminal device selects the third, the (k−1)th and the k-th terminal devices, the first password will be transmitted to the first, third, k−1)th, and k-th terminal devices. According to the second embodiment of the present invention, because a first password will be sent as a response to the user who sent the e-mail, the user who sent the e-mail can be appropriately identified.

Next, in the second embodiment of the present invention, the server will receive an e-mail containing the first password transmitted from a print request terminal belonging to a user requesting printing and is one of the terminal devices that received the first password. Thus, for the first, third (k−1)th, and k-th terminal devices that form the aforementioned group, or the server, the first password can act as a key to identify the image information (i.e., the image information transmitted from the data transmission terminal device).

In addition, the identification means of the server will identify , based upon the content of the e-mail, an m-th image forming device from amongst the first to n-th image forming devices to execute image formation based upon the image information (where m is a positive integer, and 1≦m≦n). First, when a image forming device desired by a user is specified in a predetermined form somewhere in an e-mail, the identification means will decode this identification, and will identify the image forming device as the one desired by the user. In addition, if there are a plurality of terminal devices that received the transmission of the first password, the identification of the m-th image forming device will generally be performed a plurality of times. In other words, when an e-mail is transmitted from the third terminal device, in response thereto, the m₁-th image forming device will be specified, the m₂-th image forming device corresponding to the k−1)th terminal device will be specified, and the m₃-th image forming device corresponding to the k-th terminal device will be specified. Of course, situations in which m1=m2, m1=m2=m3, etc. are also possible. Then, the m₁-th, the m₂-th, and the m₃-th image forming devices will be those desired by the users of the third, the (k−1)th, and the k-th terminal devices. For example, an image forming device will be selected for each user that is located closest to their positions.

Then, in the second embodiment of the present invention, the image data formed based upon the image information identified by the first password and the predetermined second password that identifies the image data will be transmitted to, for example, the m₁-th, m₂-th, and m₃-th image forming devices. As noted above, if the m₁-th, m₂-th, and m₃-th image forming devices are uniquely specified for each user, the second password will also be unique for each user (i.e., there will be a plurality of second passwords). In addition, the second password will be transmitted to the print request terminal devices, e.g., the third, (k−1)th and the k-th terminal devices.

In this way, each user that make up a group can identify the best image forming device to execute image formation, and the second password received by each user cam be used as a key to execute image formation with respect to the image data in the identified image forming devices.

Note that the “paper” in the present invention not only means a sheet of paper composed of pulp or the like, but also means any media that can be printed upon by applying toner thereto, such as for example an OHP sheet.

As noted above, because the present invention adopts a configuration that sends and receives e-mail containing image information and passwords that correspond thereto, image formation can, for example, be executed out of the office by employing a password as a key and not via a registration process. Thus, because a registration process will no longer be necessary, the users and administrator of the image forming device need not perform additional work, and will be freed from this burden. Of course, the cost of this image forming system can be made more reasonable because it is possible to eliminate the cost of the registration process.

In addition, for the same reasons, the image forming system of the present invention is not open just to users who have completed a registration process, but instead is open to all users that can send and receive e-mail. When one considers that almost all portable terminal devices for personal use such as PCs, portable telephones, and the like, are equipped with software that can send and receive e-mail, it is not going to far to say that the image forming system of the present invention is open to almost everybody. Thus, one can obtain extremely good advantages by using the present invention, in that the scope of the market for the present invention will, as a general rule, not be limited.

The image forming system according to the present invention is a highly convenient printing tool for distributing shared printed materials amongst members of a group made up of users that are located in separate locations. As noted above, a user can take the initiative and identify the best image forming device for him or her by transmitting e-mail containing the first password to the server. Thus, a situation can be avoided in which sharing printed materials amongst a group is difficult because the actual location in which the image formation is performed is extremely far away from certain users.

In addition, this configuration will also produce the following effects. For example, when printed material based upon certain image information is to be shared between two users, one method of solving this problem is to transmit the image information from the user that is presently in possession thereof to the user that wants it. However, the size of the image information may increase the time needed to transmit it and the cost of doing so. In addition, this method cannot be used when the terminal device that the user wanting the information employs to receive the image information is not compatible therewith. However, the present invention does not have these drawbacks. As is clear from the aforementioned configuration, this is because there is no need for two users to exchange image information between them, and because the user who does not have the image information can obtain it if he or she has a terminal device (e.g., a portable telephone) that can receive the first and second passwords.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 shows a schematic diagram of an image forming system according to one embodiment of the present invention;

FIG. 2 shows a schematic diagram of the configuration of a server shown in FIG. 1;

FIG. 3 shows a schematic diagram of the configuration of a printing device shown in FIG. 1;

FIG. 4 is a flowchart showing the process flow (performed on a PC) in one embodiment of the image forming system when a user is out of the office, carrying a PC, and executes printing by means of a printing device while out of the office;

FIG. 5 is a flowchart showing the process flow performed on the server) in one embodiment of the image forming system when a user is out of the office, carrying a PC, and executes printing by means of a printing device while out of the office;

FIG. 6 is a flowchart showing the process flow (performed on the printing device) in one embodiment of the image forming system when a user is out of the office, carrying a PC, and executes printing by means of a printing device while out of the office;

FIG. 7 shows an example of the distribution of an e-mail address to each printing device shown in FIG. 1,

FIG. 8 shows information relating to the password and use fee due that is sent from the server to the PC;

FIG. 9 is an example of a map showing the password and the present location of the printing device that is to execute printing that is transmitted from the server to the PC;

FIG. 10 is a flowchart showing the process flow (performed on a data transmission PC) in one embodiment of the image forming system when a user is out of the office, carrying a PC, and executes printing by means of a printing device while out of the office;

FIG. 11 is a flowchart showing the process flow (performed on the server) in one embodiment of the image forming system when a user is out of the office, carrying a PC, and executes printing by means of a printing device while out of the office;

FIG. 12 is a flowchart showing the process flow (performed on a print request PC) in one embodiment of the image forming system when a user is out of the office, carrying a PC, and executes printing by means of a printing device while out of the office;

FIG. 13 is a flowchart showing the process flow (performed on the printing device) in one embodiment of the image forming system when a user is out of the office, carrying a PC, and executes printing by means of a printing device while out of the office;

FIG. 14 is a schematic diagram showing the overall flow of the passwords in an embodiment of the present invention;

FIG. 15 shows information relating to a second password and use fee due that is displayed on a display of the printing device; and

FIG. 16 is an example of a map showing the second password and the present location of the printing device that is to execute printing that is transmitted from the server to the PC.

### DETAILED DESCRIPTION OF THE PREFERRED EMBODIMENTS

1. First Embodiment

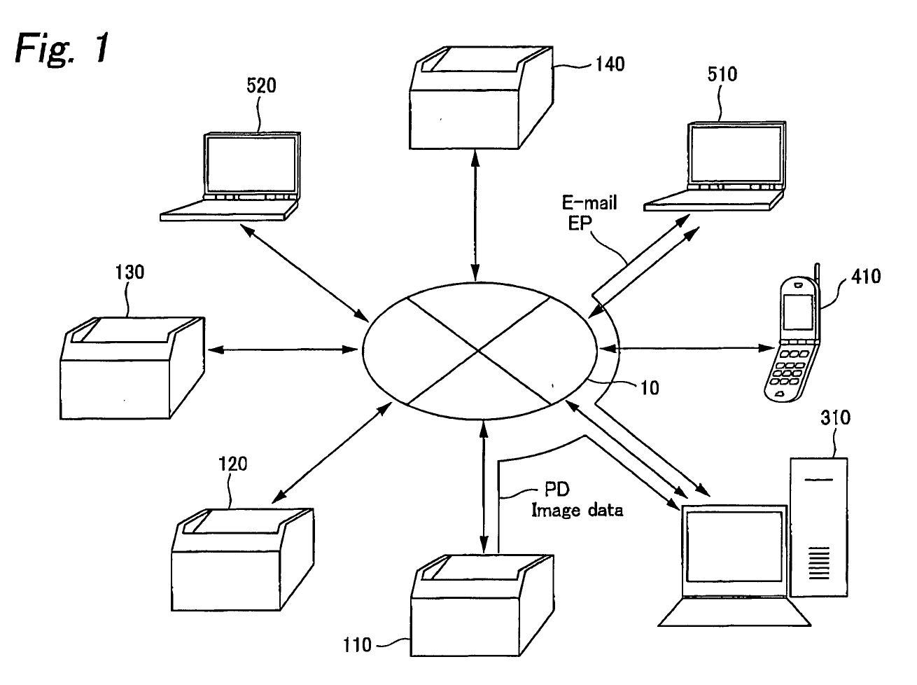

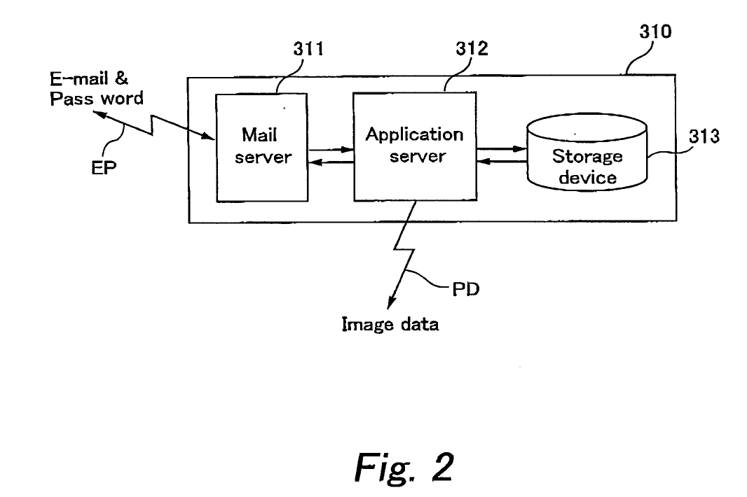

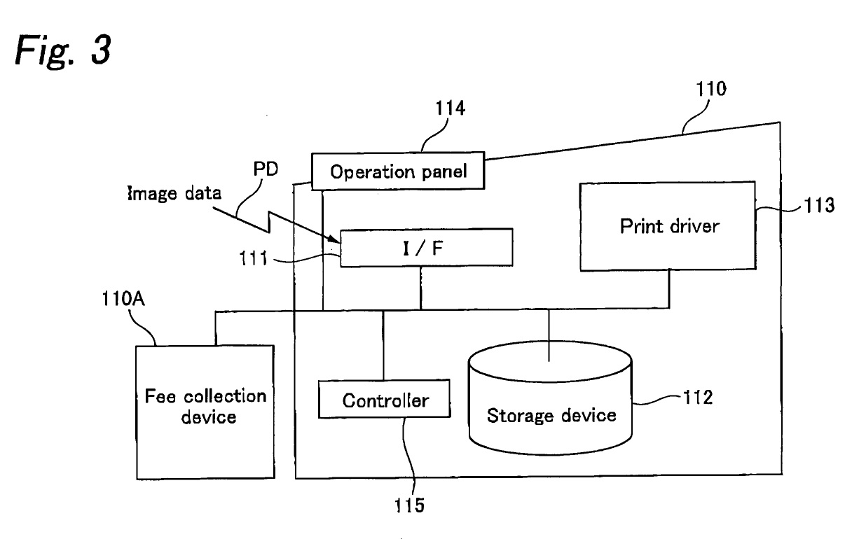

A first embodiment of the present invention will be described below with reference to FIGS. 1 to 3. FIG. 1 is a schematic diagram of an image forming system according to the present invention, FIG. 2 is a schematic diagram showing the configuration of the server shown in FIG. 1, and FIG. 3 is a schematic diagram showing the configuration of the printing devices shown in FIG. 1.

FIG. 1 shows an image forming system in which two PCs 510 and 520 that are examples of the “terminal device” of the present invention, 4 printing devices 110, 120, 130, and 140 (hereinafter referred to as printing devices 110-140), and a server 310 that is an example of a “management terminal device” of the present invention, are connected to each other via a network 10 that is an example of the “connection means” of he present invention. In addition to the PCs 510 and 520, a portable telephone 410 that is another example of the “terminal device” of the present invention is connected to the image forming system via the network 10.

The PCs 510 and 520 are loaded with publicly available word processing software and image/drawing software (not shown in the figures). Note that because PCs 510 and 520 are identical, only the configuration of PC 510 will be described below. Image information on composed of text, drawings, and the like can be produced by using this software in the PC 510.

In addition, the PC 510 ha this embodiment includes e-mail software (not shown in the figures) that allows one to send and receive e-mail. A user of the PC 510 can transmit e-mail to the other PC 520 or the server 310 by using the e-mail software. Image information can, for example, be attached to an email as an attached file, and an e-mail having this attached file or which contains image information can then be transmitted. Note that e-mail having this type of attached file is typically formed from an attached file composed of image information, and an e-mail text message (e.g., a notice that informs one that the attached file is attached, a simple greeting, a form letter, or the like). Note that unless otherwise noted, the term “e-mail” will hereinafter mean an e-mail which contains image information.

As shown in FIG. 2, the server 310 includes a mail server 311, an application server 312, and a memory device 313. The mail server 311 is equipped with well-known e-mail send/receive functionality such as SMTP, POP3, and the like, and receives e-mail containing image information that was transmitted from the PCs 510 and 520. The application server 312 will issue a password in order to identify image information from amongst the e-mail containing image information received by the mail server 311. A specific example of this password is provided below. In addition, the application server 312 will produce image data in a format that can be printed by the printing devices 110-140, based upon the image information. Note that the password will be transmitted by the mail server 311 to the PC 510 or PC 520, and the image data will be transmitted to the printing devices 110-140 by the application server 311 equipped with well-known network functionality such as FTP, HTTP, and the like. The memory device 313 is, for example, random access memory that has a well-known construction, stores e-mail containing image information received by the mail server 311, and as described below, stores “supplemental data” that is transmitted in lieu of or in addition to the password.

As shown in FIG. 3, the printing devices 110-140 each include an interface 111 (hereinafter referred to as I/F), a memory device 112, a print driver 113, an operation panel 114, and a controller 115. Note that only the configuration of printing device 110 will be described below because the printing devices 110-140 have identical configurations. In the present embodiment, the I/F 111 will receive the aforementioned password and image data transmitted from the server 310. The memory device 112 is, for example, random access memory that has a well-known construction, and can store the password and image data read into the printing device 110 via the I/F 111. The print driver 113 manages the actual printing (image formation) in the printing device 110 based upon the image data transmitted from the server 310. The operation panel 114 is a user interface composed of various buttons that allow a user to execute printing on the printing device 110, and a display that serves to notify the user that the printing device 110 has completed printing. In the present embodiment, the operation panel 114 is configured to allow the user to input a password. The controller 115 performs integrated control of each component. In the present embodiment, when a password is not input, the controller 115 will prevent printing based upon the image data from occurring.

In addition, in the present embodiment, a fee collection device 110A is installed on the printing device 110. A starting device is mounted in the fee collection device 110A, and generates a signal which both serves to allow operation of the operation panel 114 after a coin is inserted from a coin input slot (not shown in the figures), and also serves to permit the initiation of printing with the print driver 113. Thus, if a user of the present embodiment does not insert a predetermined fee into the fee collection device 110A, the print driver 113 will be locked, and the printing device 110 cannot be used.

Note that the most effective configuration of the present embodiment is when printing devices 110-140 are scattered across a broad area such as a city or a region, and the PCs 510 and 520 are portable and can be used out of the office (and if there are large numbers of both printing devices and PCs),

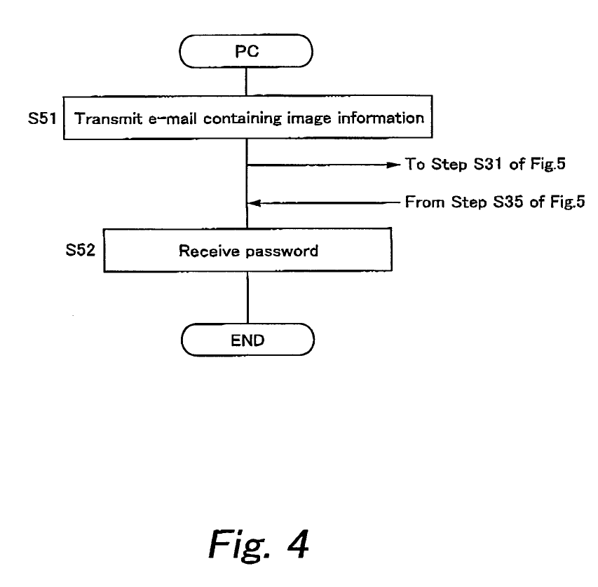

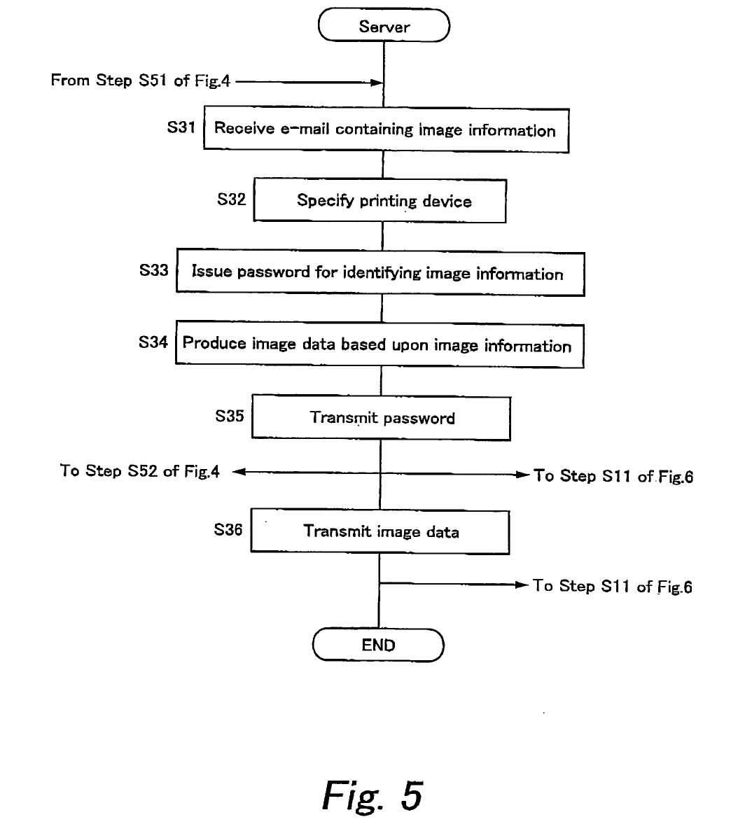

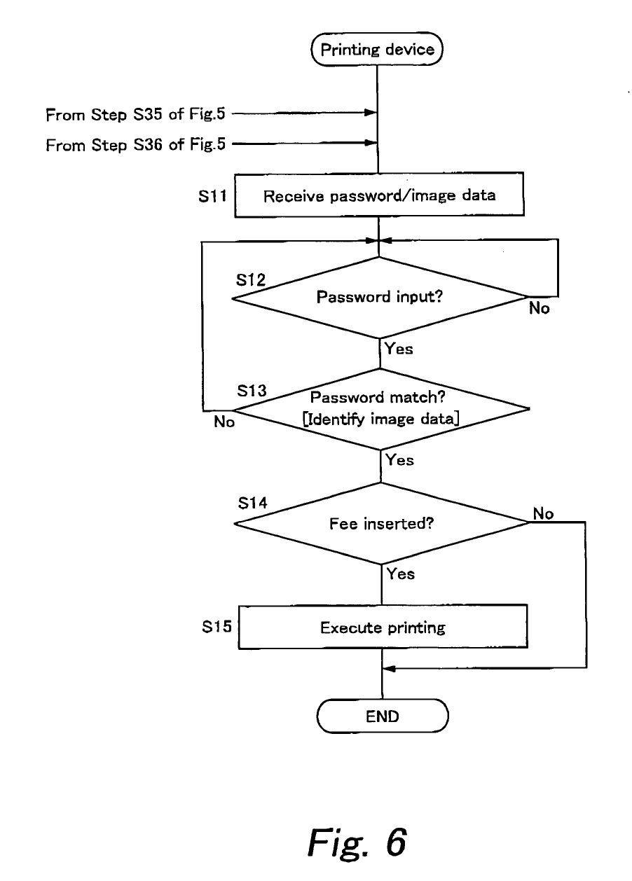

An image forming system with this configuration can for example be used as shown in FIGS. 4 to 6, and the following effects can be obtained thereby. Figs, 4 to 6 are flowcharts that show the process flow when, for example, a user of the image forming system of the present embodiment carries a PC while out of the office, and executes printing by means of a printing device while out of the office. FIG. 4 is a flowchart for the PC, FIG. 5 is a flowchart for the server, and FIG. 6 is a flowchart for the printing device. Note that for simplicity, the description below will focus on the PC 510, the printing device 110, and the server 310 in FIG. 1. In other words, PC 510 will be described as an example of the “data transmission terminal device” of the present invention, and the printing device 110 will be described as an example of the “m-th image forming device” of the present invention.

First, the user will employ the word processing software and/or the image/drawing software in the PC 510 to produce image information composed of text, drawings, and the like. As shown by the letters “EP” in FIGS. 1 and 2, the user will then transmit an e-nail having the aforementioned image information attached there to the server 310 (Step S51 of FIG. 4), and the server 310 will receive the e-mail containing the image information in the mail server 311 (Step S31 of FIG. 5).

Next, the mail server 311 will identify one of the printing devices 110-140 in FIG. 1 which will actually print the image information contained in the e-mail (Step S32 of FIG. 5). This process may also identify the printing device to which the password and image data transmission processes performed in Steps S35 and S36 of FIG. 5 will be targeted. Specific examples of this identification process are provided below.

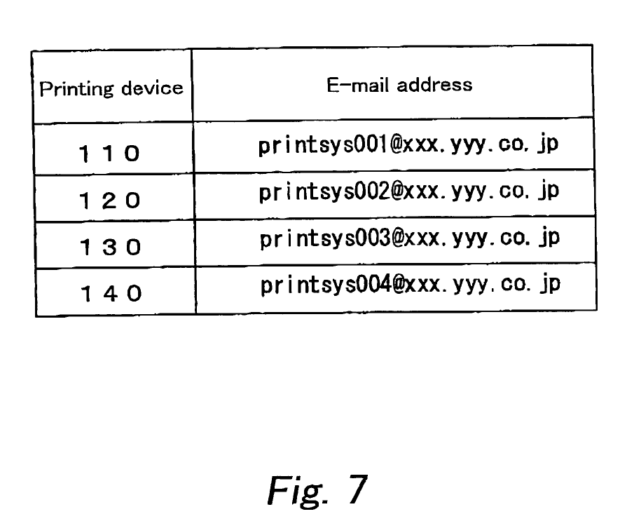

In one example, e-mail addresses that are employed as the addressees of the e-mail received by the mail server 311 will be used. For example, as shown in FIG. 7, an e-mail address will first be pre-assigned to each printing device 110-140 that is connected to the network 10. The numbers 110 to 140 in the left hand column of FIG. 7 correspond to the reference numbers in FIG. 1. Then, by using any of the e-mail addresses shown in FIG. 7 as the addressee of the e-mail to be sent in Step S31, the user will be able to specify one of the printing devices 110 to 140. For example, if the addressee is “printsys001@xxx.yyy.co jp”, the specified printing device will be printing device 110, and if the addressee is “printsys004@xxx.yyy.co.jp”, the specified printing device will be printing device 140. Ultimately, this allows the user to take the initiative and select a printing device.

In a second example, another way in which the user can take the initiative and specify a printing device is by adopting a configuration in which the printing device desired by the user is described in the text of the e-mail in accordance with a predetermined procedure (e.g., describing the number of the printing device desired by the user as an argument of a predetermined statement), and the server 310 then deciphers this and specifies the printing device.

In a third example, a method in which the server 310 will take the initiative can be considered as a printing device specification process. For example, if the current location of a user that is out of the office can be confirmed, the server 310 can select the printing device closest to this location, and then identify this printing device. This method is useful if the locations of all of the printing devices 110-140 that make up the image forming system cannot be confirmed by the user.

Regardless of the specification process employed, a printing device desired by the user or determined by the server 310 will be selected, and this printing device will actually perform the printing Note that, depending on the particular situation, there may be a plurality of printing devices specified by the aforementioned specification process (i.e., the “m-th image forming device” of the present invention may be read as “image forming devices m₁, m₂, m₃, . . . mₚ”, with 1≦m₁, m₂. . . mₚ≦n). Note also that, as noted above, the printing device specified by the specification process of the present invention is assumed to be printing device 110 in FIG. 1.

Next, the mail server 311 will pass the e-mail containing the image information to the application server 312, and a password that serves to identify the image information will be issued by the application server 312 (Step S33 of FIG. 5). Note that when this occurs, the mail server 311 will notify the application server 312 that the printing device specified via the aforementioned specification process is, as noted above, printing device 110. Then, the application server 312 will produce image data based upon the aforementioned image information (Step S34 of FIG. 5). Here, the production of image data means a process that converts the data format of the image information into one that can be used in the printing device 110. The conversion process can differ in situations in which, for example, the specified printing device is the printing device 120 and not the printing device 110, and the data format of the image data that can be handled by the printing device 120 is different from that of the printing device 110. The image data is in, for example, a page description language such as PostScript, PCL or the like. Note that because the image information and image data has substantially the same content, the password can identify both the image information and image data.

Here, the “password” may be formed by basically any method, but specific examples thereof are as follows. In the present embodiment, the password need not be complicated because, as will become clear later, the password need only be valid for a comparatively short period of time. Thus, in a first example, when the password is composed of text and numbers, text and numbers selected by the user can be used as a predetermined password. In a second example, a predetermined password can be formed by having the user select, for example, a text string, and then having the application server 312 add a random number string thereto. Note that it is also possible to, for example, insert a selected text string and number string in the text of the e-mail in accordance with a predetermined procedure (e.g., describing the text string and the number sting as an argument of a predetermined statement), and then having the server 310 decipher this. In a third example, even if the user does not select a text ring and a number string a predetermined password may is formed in the application server 312 by, for example, referring to the address of the e-mail that was sent, and then setting the first three letters of the address to be all or a part of the password (e.g., if the e-mail address is “abc@xxx.yyy.cojp”, the “abc” will be used as the password).

Regardless of which method is used, it is preferable that if a comparatively simple password is issued, the password produced be one which the user will have difficulty forgetting. In particular, as noted above, the danger of a user completely forgetting his or her password can be further avoided if the user sets the password by selecting a text or number string, or by using some portion of the e-mail address of the PC 510.

Note that in any of the methods described above, a password that is to be issued to a user cannot be the same as a password that was previously issued another user, and thus it goes without saying that a process that serves to avoid this is needed. A specific example of this would be a process in which a password to be issued to a user is compared to all of the plurality of passwords previously issued, the password to be issued would be cancelled and a new password issued if there were any matches therewith, and if there are no matches, then the password to be issued would then be issued as is to the user. In addition, the length, complexity, or type of password according to the present invention can be suitably modified in accordance with the number of users that are assumed to simultaneously use the image forming system Note that for the same of simplicity, the password described below will be issued as “kcm0001”, and composed of a text string and a number string,

Next, if a password for identifying image information or image data is issued, then the server 310 will transmit the password “kcm0001” to both the PC 510 and the printing device 110 specified in Step S32 of FIG. 5 (Step S35 of Fig, 5). Next, the server 310 will transmit the image data produced in Step S34 of FIG. 5 to the printing device 110, as shown by the letters “PD” of FIGS. 1 to 3 (Step S36 of FIG. 5). Note that the password will be transmitted to the PC 510 (the sender), but a process may also be performed in which, if no e-mail address is available for this purpose, an error message that indicates this will be received by the PC 510, and then the password and the image data that corresponds thereto will be deleted.

On the other hand, the user of the PC 510 will receive the password “kcm0001” (Step S52 of FIG. 4) from the server 310. By using the password “kcm0001”, as noted below, the user can identify his or her image data from amongst the plurality of image data stored in the storage device 112 of the printing device 110. In addition, the printing device 110 will receive the password “kcm0001” and the image data transmitted from the server 310 via the I/F 111 (Step S11 of FIG. 6), and will be stored as integrated data in the storage device 112. The printing device 110 can print based upon the received image data, but will not print unless the password is input.

Note that as described above, the image data will be transmitted to the printing device 110 after the password is transmitted thereto. However, an embodiment of the present invention can be adopted in which instead of this, the image data will be transmitted to the printing device 110 in a state in which it is locked with the password. The main point is that although the locking process will be substantially different depending upon whether it is performed in the server 310 or in the printing device 110, either alternative may be adopted with no problem.

At this point, the preparatory steps need to actually perform printing are complete.

Next, the user of the PC 510 will head toward the actual location of the printing device 110, and will use the printing device 110 to actually execute printing. In other words, the printing device 110 will first wait for the password “kcm0001” to be input (Step S12 of FIG. 6). In this situation, if the printing device 110 is located, for example, in a convenience store or another publicly accessible place, another person will of course be able to directly print or copy documents with the printing device 110 while the printing device 110 is waiting for the password to be input.

Next, the user of the PC 510 will head toward the place where the printing device 110 is located, and when the user inputs the password via the operation panel 114, it will be determined whether or not the input password matches any of the passwords stored in the storage device 112 (Step S13 of FIG. 6). Here, if it is determined that there is a match (i.e., if the input password is “kcm0001”), the process will move to the next step (from Step S13 to Step S14 of FIG. 6), and if it is determined that there is no match, then the process will return to the password input waiting step (from Step S13 to Step S12 of FIG. 6). If there is a match, then the determination of a password match and the identification of the image data will be performed.

If a password match has been found, then the printing device 110 will then wait for the predetermined fee to be inserted into the fee collection device 110A by the user (Step S14 of FIG. 6). Here, for example, if the fee has not been inserted within a fixed period of time, all of the processes will be completed as if there were no password match and image data identification (Step S14 to Step END of FIG. 6). Thus, if the fee collection device 110A is provided, compensation for the use of the image forming system can be reliably collected from the user. Note that in the above situation, a process may also be performed in the event that the reception and storage of the password and the image data (Step S11 of FIG. 6) has not yet occurred.

On the other hand, if the fee is inserted within a fixed period of time, the printing device 110 will release the lock on the print driver 113, and printing will actually execute based upon the identified image data (Step S15 of FIG. 6), In this way, the user can obtain printed material even if he or she is out of the office.

As described above, according to the present embodiment, by obtaining the password “kcm0001” as a response to an e-mail containing image information that was transmitted to the server 310 and which identifies the transmitted image information in the printing device 110, the user can execute printing with the printing device 110 based upon the image information. With this configuration, not only will the same password not be issued to a different user, but because each user (more accurately, each image information or each image data produced therefrom) will be uniquely identified, there will be no need to perform a pre-registration process in, for example, the server 310 because the user that sent the e-mail will be identified. Thus, according to the present embodiment, the user and the system administrator can be freed from having to perform a complicated registration process. In addition, if a registration process is not necessary, then this means that the image forming system according to the present invention will be open to all users having a terminal device that can send and receive e-mail, and not just to users who have completed a registration process Thus, the market for the image formation system according to the present embodiment can be expanded.

Note that although the “data transmission terminal device” of the present invention was described above as the PC 510, the present invention is of course not limited to this. For example, as shown in FIG. 1, the “data transmission terminal device” of the present invention can be a portable telephone 410 capable of sending and receiving e-mail.

In sum, the “terminal device” of the present invention may be capable of sending and receiving e-mail, and thus the “terminal device” of the present invention can use as is any type of technology that is used or capable of being used as e-mail technology. For example, as is well known, if an e-mail address other than that of the addressee is entered in the so called “cc” space of e-mail software, it will also be possible to add a terminal device to which the password from the server 310 will be sent that is different than the PC 510 of the sender (or change the e-mail address from that of the PC 510 to another terminal device). In the alternative, if e-mail address rejection is used, technology that refuses receipt of an e-mail in the server 310, technology that sets the maximum size of all e-mail that can be received, or the like, can be employed in situations in which, for example, the e-mail address is a free e-mail account.

Furthermore, in the aforementioned embodiment, the process of converting the transmitted image information to the image data is performed in the server 310. However, this conversion process also includes a conversion from image information to image data in which any of the print settings are incorporated therein, such as the size of the paper to be used for printing, the use of color printing or monochrome printing, and the like. In this configuration, the server 310 or the printing device 110 must be notified of the print settings. However, like with the methods described above, such as the method in which the user selected the password, or the method in which the user selected the printing device, a method may be adopted in which, for example, the text of the e-mail will be used to perform this notification.

Thus, if image data that incorporates the print settings is produced, it will be extremely convenient for the user because he or she may in substance need only to input the password into the printing device 110, and then start the printing immediately thereafter.

Handling of the password and image data stored in the printing device

In addition, what occurs after the password and image data are received by the printing device 110 and stored in the storage device 112 (e.g., whether these items will continue to be stored there for a long period of time, and the like) has not been particularly mentioned in the aforementioned embodiment, however the following processes may for example be performed in connection therewith. In a first example, if a regular password is input and printing based on the corresponding image data is completed, the password and the image data may be deleted from the storage device 112.

In a second example, the password and image data may be deleted in situations in which, after the password and image data are received, a fixed period of time (e.g., three days, one week, etc.) has expired, or in addition to this, the password has not been input with this time period. By retaining passwords and image data that appear to have been left by users for a long period of time, the storage capacity of the storage device 112 may continue to be wastefully used, and thus the aforementioned examples will be convenient for the system administrator and for other users that will use the image forming system. In addition, for a user that appears to have left his or her password and image data in the printing device, it is not considered desirable tat one's own image data be retained in a public printing device for a long period of time, and thus automatically deleting the image data can be desirable from the point of view of protecting the privacy of the user.

Note that as described above, there is no need for the password to be complex because it is preferable that the password be valid for only a comparatively short period of time. In addition, in the aforementioned embodiment, because the password is made unique in order to identify the image information in the e-mail containing the image information that a certain user transmitted at a certain time, and moreover, as noted above, it is preferable it a configuration be adopted in which the so-called used passwords and image data are completely deleted, the confidentiality of the image information or the image data can be well maintained.

Furthermore, with the configuration described above, when a certain user cannot go to the place where the printing device is located even though he or she is in possession of a password, the user can tell another person that is near the printing device what the password is, and have that other person perform the printing instead. Although it is thought to be difficult to maintain confidentiality when the validity of the password or the image data is effectively managed over a long period of time, and when the password is divulged to a third party when the user tells another person what the password is, confidentiality can be maintained at an even better level in the aforementioned embodiment because it is preferable that the password be valid for only a comparatively short period of time, and that the password be valid for only one use. Supplemental information transmitted in lieu of or in addition to the password

In the present embodiment, the server 310 may be configured so that in lieu of or in addition to the transmission of the password to the PC 510 (Step S35 of FIG. 5), “predetermined supplemental information” will be transmitted to the PC 510. Here, predetermined supplemental information can be thought of as a variety of information, In a first example, the server 310 can be configured such that if it does not successfully receive an e-mail containing image information for some reason, or if the reception thereof is rejected, the server 310 will transmit an “error message” in lieu of the issuance and transmission of a password.

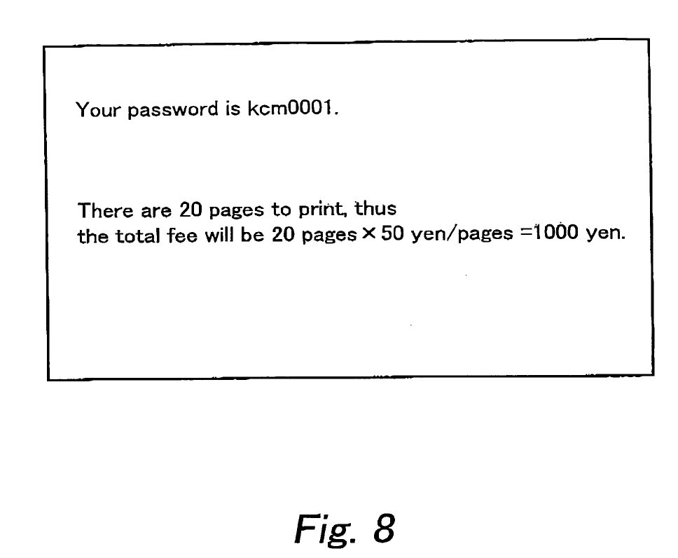

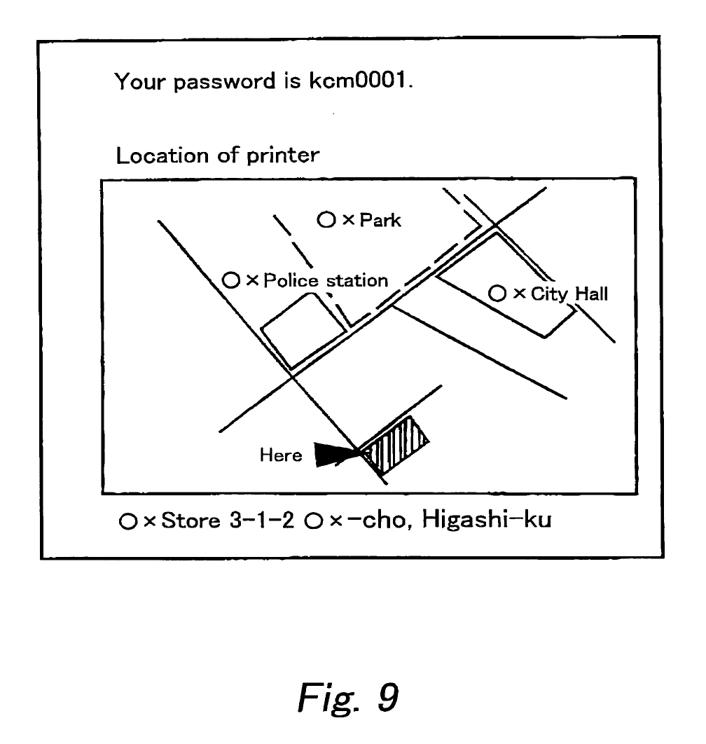

In a second example, the server 310 can be configured such that in addition to the issuance and transmission of the password, a “preview screen” in accordance with the print settings (e.g., the size of the paper to be used, whether color printing is to be executed, and the like) desired by the user of the PC 510 will be transmitted. In a third example, a “fee table” can be transmitted in situations in which a use fee” for printing or for various settings and the like have been established. An example of a “use fee” is shown in FIG. 8. In a fourth example, the server 310 can transmit a “map” showing the location of the store (such as a convenience store) in which the printing device that was specified in the “specification process” referred to in Step S32 of FIG. 5 (i.e., the printing device desired by the user or determined by the server 310 to execute printing) is located, or can transmit the name of the store. An example of this is shown in FIG. 9.

In a fifth example, “predetermined supplemental information” that can generate advertisement fee income from a predetermined sponsor can be transmitted to a user.

In one version of the fifth example, the server 310 can transmit “image data” or “music data” that contains an advertisement for the store in which the printing device desired by user or determined by the server 310 to execute printing is located, the shopping street on which the store is located, a commercial establishment near the store, or a company that is connected with the administration of the image forming system (e.g., the company that contracted with the store, hereinafter referred to as the system administration partner). With this configuration, the store; the shopping street, the commercial establishment, or the system administration partner can be assumed to be a sponsor. However, “image data” includes images that can be used as wallpaper on the user's terminal device, “music data” includes music samples such as songs and the like, and when the terminal device used by the person transmitting the e-mail is, for example, the portable telephone 410, “music data” can be music to be used as a ring tone. Here, it can be assumed that a sponsor is using the supplemental information to conduct advertising, but the supplemental information can be used by persons or organizations other than a sponsor.

In a second version of the fifth example, a discount coupon, a complementary ticket, or the like for the store, the shopping street, or the commercial establishment can be transmitted. With this configuration as well, the store or the like can be the sponsor. However, the “discount coupon” can also be for future usage of the image forming system.

As described above, “predetermined supplemental information” can be various types of information, but regardless of the type thereof, if this information is transmitted in lieu of or in addition to the password, it will provide the user with an opportunity to obtain beneficial information, and will allow advertisement fee income to be generated.

Note that it is also possible to continually transmit certain “supplemental information”, but in lieu of the supplemental information or in addition thereto, it is also helpful to adopt a configuration which will select supplemental information to transmit in response to the content of the e-mail that was sent, or in response to the user of the terminal device that sent the e-mail. For example, when the “predetermined supplemental information” includes a “preview image”, the significance of specially informing the user that his or her desired printing is normal and has no abnormalities will decline. Thus, depending on the situation, it is also possible to eliminate processes, such as omitting the transmission of the “preview image”.

In addition, if the “predetermined supplemental information” includes image data containing advertising for a store in which the printing device that is to execute the printing desired by the user or determined by the server 310 is located, there will be a heightened need to select the image data to be transmitted in accordance with the store. In this type of situation, a configuration may be adopted in which image data that includes advertisements for all stores in which the printing devices 110-140 are located is stored in the storage device 313 of the server 310, and the optimal image data is selected therefrom In this configuration, as noted above, when the user transmits an e-mail together with the selection of the printing device, the image data to be transmitted may be selected in accordance with the content of the e-mail (i.e., the store in which the selected printing device is located), or when the server 310 decides the printing device to execute image formation for the convenience of the user, the image data to be transmitted may be selected in accordance with the printing device. The above meanings are included in the terms “in accordance with the content of the e-mail”, or “in accordance with the user of the data transmission terminal device”.

2. Second Embodiment

A second embodiment of the present invention will be described below with reference to FIGS. 1 to 3. FIG. 1 is a schematic diagram of an image forming system according to the present invention, FIG. 2 is a schematic diagram showing the configuration of the server shown in FIG. 1, and FIG. 3 is a schematic diagram showing the configuration of the printing devices shown in FIG. 1.

FIG. 1 shows an image forming system in which two PCs 510 and 520 that are examples of the “terminal device” of the present invention, 4 printing devices 110, 120, 130, and 140 (hereinafter referred to as printing devices 110-140), and a server 310 that is an example of a “management terminal device” of the present invention, are connected to each other via a network 10 that is an example of the “connection means” of the present invention. In addition to the PCs 510 and 520, a portable telephone 410 that is another example of the “terminal device” of the present invention is connected to the image forming system via the network 10.

The PCs 510 and 520 are loaded with publicly available word processing software and image/drawing software (not shown in the figures). Note that because PCs 510 and 520 are identical, only the configuration of PC 510 will be described below. Image information composed of text, drawings, and the like can be produced by using this software in the PC 510.

In addition, the PC 510 in this embodiment includes software (not shown in the figures) that allows one to send and receive e-mail. A user of the PC 510 can transmit e-mail to the other PC 520 or the server 310 by using the e-mail software. Image information can be attached to the e-mail as an attached file, for example, and an e-mail having this attached file or which contains image information can then be transmitted. Note that the e-mail that includes this type of attached file is typically formed from an attached file composed of image information, and an e-mail text message (e.g., a notice that informs one that the attached file is attached, a simple greeting, a form letter, or the like). Note that unless otherwise noted, the term “e-mail” will hereinafter mean an e-mail which contains image information.

As shown in FIG. 2, the server 310 includes a mail server 311, an application server 312, and a memory device 313. The mail server 311 is equipped with well-known e-mail send/receive functionality such as SMTP, POP3, and the like, and receives e-mail containing image information that was transmitted from the PCs 510 and 520. The application server 312 will issue a first password in order to identify the image information in the e-mail received by the mail server 311. In addition, when the first password from the user of the PC 510 or PC 520 is transmitted, a second password will also be issued in order to identify the image data formed based upon the image information from the user. A specific example of the first and second passwords will be described below. In addition, the application server 312 will produce image data in a format that can be printed by the printing devices 110-140, based upon the image information attached to the e-mail. Note that the password will be transmitted by the mail server 311 to the PC 510 or PC 520, and the image data will be transmitted to the printing devices 110-140 by the application server 311 equipped with well-known network functionality such as FTP, HTTP, and the like. The memory device 313 is, for example, random access memory that has a well-known construction, stores e-mail containing image information received by the mail server 311, and as described below, stores “supplemental data” that is transmitted in lieu of or in addition to the password.

As shown in FIG. 3, the printing devices 110-140 each include an interface 111 (hereinafter referred to as I/F), a memory device 112, a print driver 113, an operation panel 114, and a controller 115. Note that only the configuration of printing device 110 will be described below because the printing devices 110-140 have identical configurations. In the present embodiment, the I/F 111 will receive the aforementioned second password and image data transmitted from the server 310. The memory device 112 is, for example, random access memory that has a well-known construction, and can store the second password and image data read into the printing device 110 via the I/F 111. The print driver 113 manages the actual printing (image formation) in the printing device 110 based upon the image data transmitted from the server 310 The operation panel 114 is a user interface composed of various buttons that allow a user to execute printing on the printing device 110, and a display that serves to notify the user that the printing device 110 has completed printing. In the present embodiment, the operation panel 114 is configured to allow the user to input the second password. The controller 115 performs integrated control of each component. In the present embodiment, when the second password is not input, the controller 115 will prevent printing based upon the image data from occurring.

In addition, in the present embodiment, a fee collection device 110A is installed on the printing device 110. A stating device is mounted in the fee collection device 110A, and generates a signal which both serves to allow operation of the operation panel 114 after a coin is inserted from a coin input slot (not shown in the figures), and also serves to permit the initiation of printing with the print driver 113. Thus, if a user of the present embodiment does not insert a predetermined fee into the fee collection device 110A, the print driver 113 will be locked, and the printing device 110 cannot be used.

Note that the most effective configuration of the present embodiment is when the printing devices 110-140 are scattered across a broad area such as a city or a region, and the PCs 510 and 520 are portable and can be used out of the office (and if there are large numbers of both printing devices and PCs).

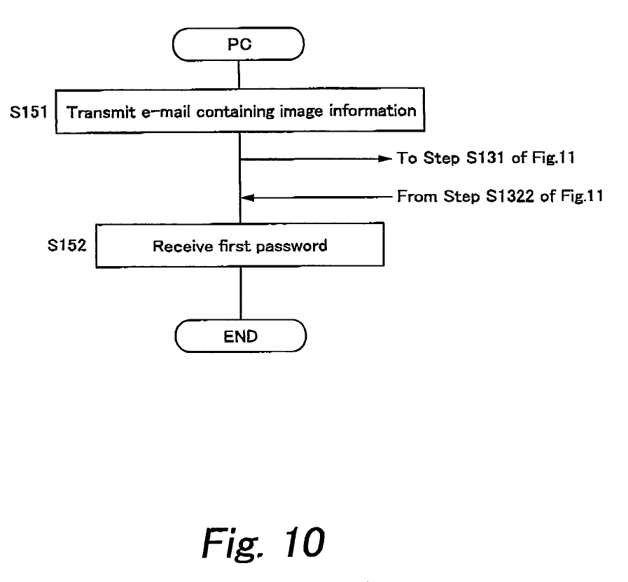

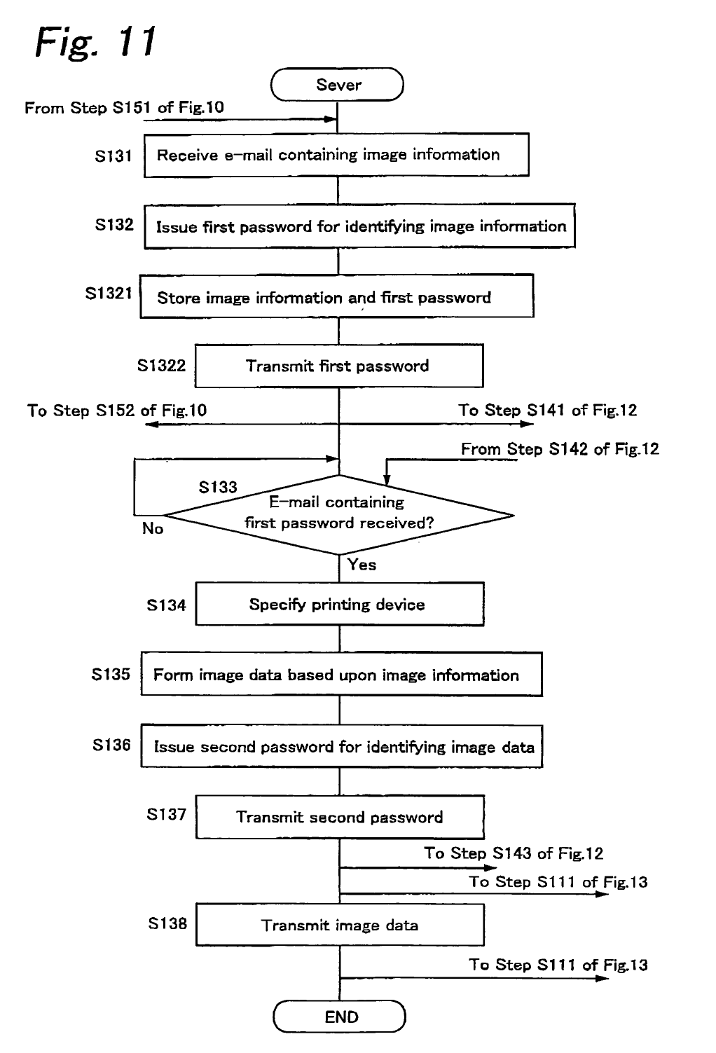

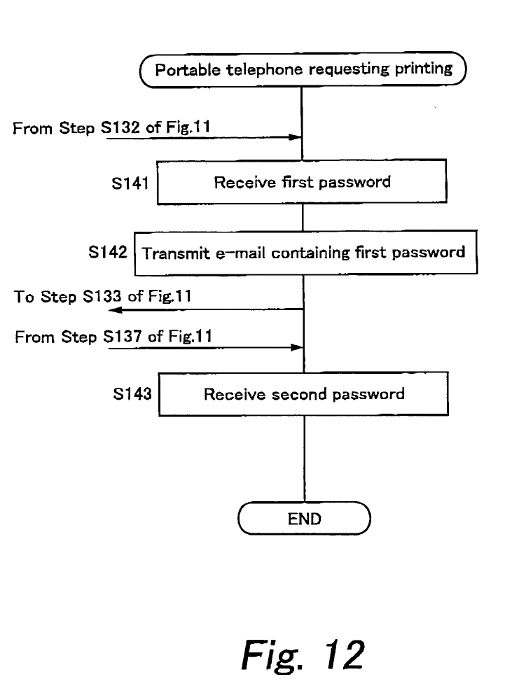

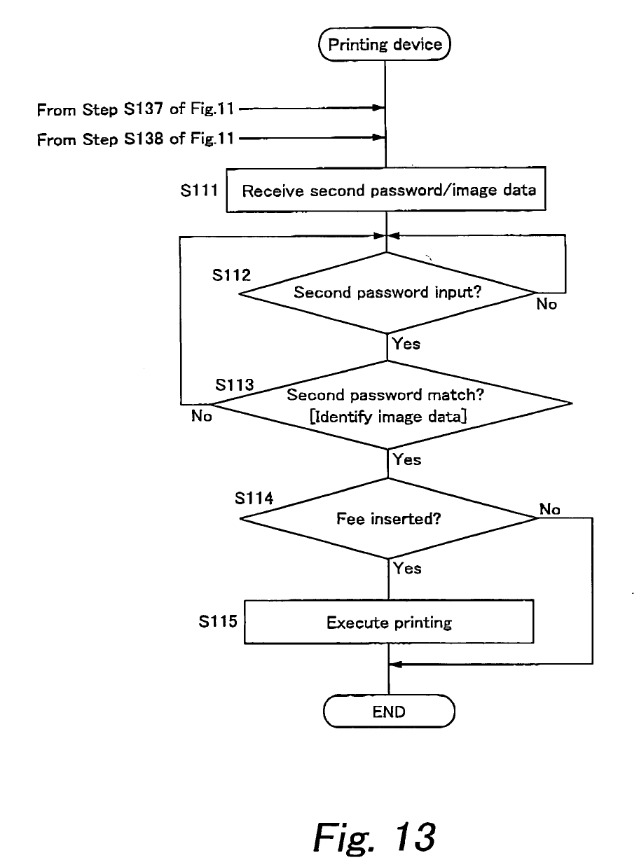

An image forming system with this configuration can for example be used as shown in FIGS. 10 to 13, and the following effects can be obtained thereby. FIGS. 10 to 13 are flowcharts that show the process flow when, for example, a user of the image forming system of the present embodiment carries a PC while out of the office, and executes printing by means of the printing device while out of the office. FIG. 10 is a flowchart for the PC that transmits the image information, FIG. 11 is a flowchart for the server, FIG. 12 is a flowchart for the PC that transmits a print request, and FIG. 13 is a flowchart for the printing device. Note that in order to simplify the description below, the PC 510 (hereinafter referred to as the data transmission PC 510) in FIG. 1 is an example of the “data transmission terminal device” of the present invention, and the portable telephone 410 (hereinafter referred to as the “print request portable telephone 410”) in FIG. 1 is an example of the “print request terminal device” of the present invention.

First, the user will employ the word processing software and/or the image/drawing software in the data transmission PC 510 to produce image data composed of text, drawings, and the like. As shown by the letters “EP” in FIGS. 1 and 2, the user will then transmit an e-mail having image information attached thereto to the server 310 (Step S151 of FIG. 10), and the server 310 will receive the e-mail containing image information in the mail server 311 (Step S131 of FIG. 11). In the present embodiment, it is assumed that the e-mail address of the portable telephone 410 is included in the content of the e-mail containing the image information (e.g., the e-mail address will be entered in the “cc” line).

Next, the mail server 311 will pass the e-mail containing image information to the application server 312, and a first password that serves to identify the image data will be issued by the application server 312 (Step S132 of FIG. 11). Thus, the image information and the first password issued so as to correspond thereto will be stored in the storage device 313 as integrated data (Step S1321 of FIG. 11). In addition, the server 310 will transmit the first password to the portable telephone 410 based upon the e-mail address of the portable telephone 410 included in the e-mail containing the image information (Step S1322 of FIG. 11). Thus, in the present embodiment, the PC 510 and the portable telephone 410 can be viewed as forming a single group in order to obtain printed material based upon the image information. Note that in the present invention, there is no limit to the number of terminal devices that form the group (e.g., PC 520 in FIG. 1 may be added to the group).

Here, the “first password” may be formed by basically any method, but specific examples thereof are as follows. In the present embodiment, the first password need not be complicated because, as will become clear later, the password need only be valid for a comparatively short period of time. Thus, in one example, when the first password is composed of text and numbers, text and numbers selected by the user can be used as a predetermined first password. In another example, a predetermined first password can be formed by having the user select, for example, a text string, and then having the application server 312 add a random number string thereto. Note that it is also possible to, for example, insert a selected text string and number string in the text of the e-mil in accordance with a predetermined procedure (e.g., describing the text string and the number string as an argument of a predetermined statement), and then having the server 310 decipher this. In a third example, even if the user does not select a text string and a number string, a method can be adopted in which a predetermined first password is formed in the application server 312 by, for example, referring to the address of the e-mail that was sent, and then setting the first three letters of the address to be all or a part of the first password (e.g., if the e-mail address is “abc@xxx.yyy.cojp”, the “abc” will be used as the password)

Regardless of which method is used, it is preferable that if a comparatively simple first password is produced, it be one which the user will have difficulty forgetting. In particular, as noted above, the danger of a user completely forgetting his or her first password can be further avoided if the user sets the first password by selecting a text or number string, or by using some portion of the e-mail address of the PC 510.

Note that in any of the methods described above, a first password that is to be produced cannot be the same as a first password that was previously produced for another user, and thus it goes without saying that a process that serves to avoid this is needed. A specific example of this would be a process in which a first password to be issued to a user is compared to all of the plurality of first passwords previously issued, the first password to be issued would be cancelled and a new first password issued if there were any matches therewith, and if there are no matches, then the first password to be issued would then be issued as is to the user. In addition, the length, complexity, or type of the first password according to the present invention can be suitably modified in accordance with the number of users that are assumed to simultaneously use the image forming system. Note that for the same of simplicity, the first password described below will be issued as “kcm0001”, and composed of a text string and a number string.

Next, the first password “kcm0001” transmitted as described above will be received by the portable telephone 410 (Step S141 of FIG. 12). In the present embodiment, the first password will also be transmitted to the data transmission PC 510, and the PC 510 will receive the first password (Step S152 of FIG. 10). In the description below, there are basically no further processes to be performed by the PC 510 (Step END of FIG. 10). Note that the first password will be transmitted to the e-mail address of the portable telephone 410 that was selected as the addressee, but a process may also be performed in which, if no e-mail address is available for this purpose, an error message that indicates this will be received, and then the first password and the image information that corresponds thereto will be deleted.

In the present embodiment, up to the aforementioned process, the user of the data transmission PC 510 and the portable telephone 410 will have a shared first password with regard to the shared image information.

Next, under these conditions, the server 310 will wait for the first password to be transmitted (Step S133 of FIG. 11). Here, as shown by the letters PW in FIG. 1, when the user of the portable telephone 410 wants to obtain printed materials based upon the image information, he or she will transmit an e-mail containing the first password from the portable telephone 410 to the server 310 (Step S142 of FIG. 12). This e-mail will contain both information regarding the first password, i.e., “kcm0001”, and information for identifying which of the printing devices 110-140 connected to the network is, for example, the closest to the user of the portable telephone 410 requesting printing or the best printing device for another user to go and pick up the printed material. The server 310 will identify the printing device desired by the user of the portable telephone 410 to execute the printing (Step S134 of FIG. 11).

The following examples can be used to specifically illustrate the process for identifying the printing device. In a first example, e-mail addresses that are employed as the addressees of the e-mail received in Step S133 will be used. For example, as shown in FIG. 8, an e-mail address will first be pre-assigned to each printing device 110-140 that is connected to the network 10. The numbers 110 to 140 in the left hand column of FIG. 7 correspond to the reference numbers in FIG. 8. Then, by using any of the e-mail addresses shown in FIG. 8 as the addressee of the e-mail to be sent in Step S142, the user will be able to identify one of the printing devices 110 to 140. For example, if the addressee is “printsys001@xxx.yyy.co.jp”, the specified printing device will be printing device 110, and if the addressee is “printsys004@xxx.yyy.co.jp”, the specified printing device will be printing device 140. Ultimately, this allows the user to take the initiative and select a printing device.

In a second example, another way in which the user can take the initiative and identify a printing device is by describing the printing device desired by the user in the text of the e-mail in accordance with a predetermined procedure (e.g., describing the number of the printing device desired by the user as an argument of a predetermined statement), and having the server 310 deciphers this and specify the printing device.

Regardless of which specification process is used, the printing device that is to actually execute the printing will be specified in accordance with the user's desire.

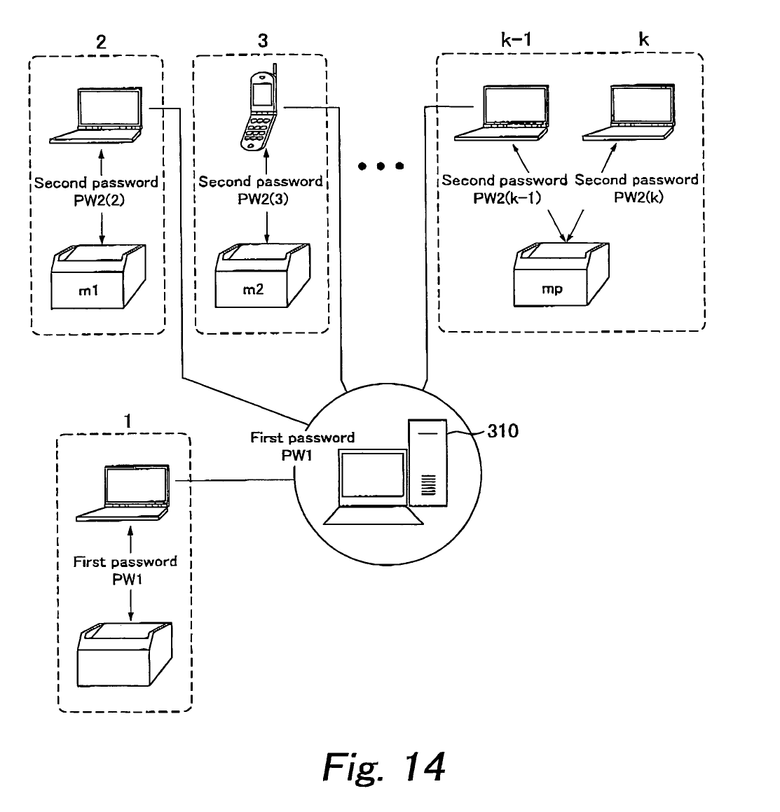

Note that there may be a plurality of printing devices specified by the aforementioned specification process in accordance with the number of “print request terminal devices” of the present invention (i.e., as shown in FIG. 14, the “m-th image forming device” of the present invention may be read as “image forming devices m₁, m₂, m₃, . . . mₚ”, with 1≦m₁, m₂, . . . mₚ≦n). In other words, the printing device 110 in FIG. 1 is the best printing device for the user of the portable telephone 410, and the printing device 140 in FIG. 1 is the best printing device for the user of the PC 520 (see dashed lines in FIG. 1), and the e-mail that each user will sent in the process of Step S142 will contain a selection of the desired printing device. Of course, the situation will occur if the printing devices and the users are spread out over a wide area. Note that below, the printing device specified by the specification process of the present invention is assumed to be the “printing device 110” in FIG. 1.

On the other hand, based upon the first password “kcm0001” contained in the e-mail received in Step S133, the server 310 can select the identity of the image information from amongst the plurality of image information stored in the storage device 313. This is because the first password and the image information is stored as integrated data in the storage device 313 (see Step S1321 of FIG. 11).

Next, the application server 312 of the server 310 will produce image data based upon the identified image information so as to be suitable for the specified printing device 110. Here, the production of image data means a process that converts the data format of the image data into one that can be used in the printing device 110. The conversion process can differ in situations in which, for example, the specified printing device is the printing device 120 and not the printing device 110, and the data format of the image data that can be handled by the printing device 120 is different from that of the printing device 110. The image data is in, for example, a page description language such as PostScript, PCL or the like.

Next, a second password will be issued which serves to identify the image data produced above (Step S136 of FIG. 11). Here, the process of forming the first password described above can be used to form the second password. Note that for the sake of simplicity, the second password described below will be issued as “kcm9901”, and composed of a text string and a number string.

As noted above, if a second password for identifying image data is to be issued, then server 310 will transmit the second password “kcm9901” to both the portable telephone 410 and the printing device 110 specified in Step S134 of FIG. 11 (Step S137 of FIG. 11)(see the letters PW in FIG. 1). Next, the server 310 will transmit the image data produced in Step S135 of FIG. 11 to the printing device 110, as shown by the letters PD in FIGS. 1 to 3 (Step S138 of FIG. 5).

On the other hand, the user of the portable telephone 410 will receive the second password “kcm9901” from the server 310 (Step S152 of FIG. 10). By using the password “kcm9901”, as noted below, the user can select his or her image data from amongst the plurality of image data stored in the storage device 112 of the printing device 110. In addition, the printing device 110 will receive the password “kcm9901” and the image data transmitted from the server 310 via the I/F 111 (Step S111 of FIG. 12), and will be stored as integrated data in the storage device 112. The printing device 110 can print based upon the received image data, but will not print unless the second password is input.

Note that as described above, the image data will be transmitted to the printing device 110 after the second password is transmitted thereto. However, an embodiment of the present invention can be adopted in which instead of this, the image data will be transmitted to the printing device 110 in a state in which it is locked with the password. The main point is that although the locking process will be substantially different depending upon whether it is performed in the server 310 or in the prnting device 110, either alternative may be adopted with no problem.

At this point, the preparatory steps need to actually perform printing are complete.

Next, the user of the portable telephone 410 will head toward the actual location of the printing device 110, and will use the printing device 110 to actually execute printing. In other words, the printing device 110 will wait for the password “kcm9901” to be input (Step S112 of FIG. 13). In this situation, if the printing device 110 is located, for example, in a convenience store or another publicly accessible place, another person will of course be able to directly print or copy documents with the printing device 110 while the printing device 110 is waiting for the second password to be input.

Next, the user of the portable telephone 410 will head toward the place where the printing device 110 is located, and when the user inputs the second password via the operation panel 114, it will be determined whether or not the input second password matches any of the passwords stored in the storage device 112 (Step S113 of FIG. 13). Here, if it is determined that there is a match (i.e., if the input password is “kcm9901”), the process will move to the next step (from Step S113 to Step S114 of FIG. 13), and if it is determined that there is no match, then the process will return to the second password input waiting step (from Step S113 to Step S112 of FIG. 13). If there is a match, then the determination of a second password match and the specification of the image data will be performed.

If a second password match has been found, then the printing device 110 will then wait for the predetermined fee to be inserted into the fee collection device 110A by the user (Step S114 of FIG. 13). Here, for example, if the fee has not been inserted within a fixed period of time, all of the processes will be completed as if there were no second password match and image data identification (Step S114 to Step END of FIG. 13). Thus, if the fee collection device 110A is provided, compensation for the use of the image forming system can be reliably collected from the user. Note that in the above situation, a process may also be performed in the event that the reception and storage of the second password and the image data (Step S111 of FIG. 13) has not yet occurred.

On the other hand, if the fee is inserted within a fixed period of time, the printing device 110 will release the lock on the print driver 113, and printing will actually execute based upon the identified image data (Step S115 of FIG. 13). In this way, the user can obtain printed material even if he or she is out of the office.

As described above, in the present embodiment, by obtaining a first password “kcm0001” and a second password “kcm9901”, the use will both identify the image information transmitted by another person to the server 310, and identify the image data produced based upon this image information in the printing device 110 that is the best for him or her, and can use the printing device 110 to execute printing based upon the image information. With this configuration, not only will the same second password not be issued to a different user, but because each user (more accurately, each image data) will be uniquely identified, there will be no need to perform a pre-registration process in, for example, the server 310 because the user that sent the e-mail will be identified. Thus, according to the present embodiment, the user and the system administrator can be freed from having to perform a complicated registration process. In addition, if a registration process is not necessary, then this means that the image forming system according to the present invention will be open to all users having a terminal device that can send and receive e-mail, and not just to users who have completed a registration process. Thus, the market for the image formation system according to the present embodiment can be expanded.

Moreover, the image forming system according to the present invention is a highly convenient printing tool for distributing shared printed materials amongst members of a group made up of users that are in separate locations. As noted above, this is because a user who receives the first password will transmit an e-mail containing the first password to the server, and thus can take the initiative and identify the printing devices 110-140 that are best for him or her. Thus, a situation can be avoided in which sharing printed materials amongst a group is difficult because the actual location in which the printing is performed is extremely far away from certain users.

In the present embodiment, the information contained in the e-mail transmitted at Step S142 of FIG. 12 for identifying the printing device that is best for the user may be included in the e-mail containing image information transmitted from the data transmission PC 510 at Step S151 of FIG. 10. In addition to this, at the point that the first password is received in Step S152 of FIG. 10, the first password and image data converted to be suitable for the printing device specified may be transmitted to the printing device. In other words, with respect to the person that transmits the image information, the first password may function as a print execution key in the printing device (In FIG. 13, “second password” should be read as “first password”). If this is done, the user of the data transmission PC 510 need only transmit an e-mail once, and thus will be beneficial.

The effect of the above in the image forming system of the present embodiment is conceptually summarized and shown in FIG. 14. First, if we assume that an e-mail containing image information transmitted from the PC inside the dashed line 1 to the server 310 includes the e-mail addresses of the PCs inside the other dashed lines 2, 3, . . . , k−1 and k shown in FIG. 14, then a first password PW(1) that serves to identify the image information will be transmitted to each PC inside the dashed lines 1, 2, 3, . . . , k−1 and k (see Step S151 of FIG. 10 to Step S1322 of FIG. 11, and Step S141 of FIG. 12). The first password PW(1) will action as a print execution key in a printing device for the user of the PC inside the dashed line 1 (see both arrows inside the dashed line 1 and FIG. 13). On the other hand, by again transmitting e-mails containing the received first password PW(1) to the server 310, the PCs inside the other dashed lines 2, 3, . . . , k−1 and k will select the printing devices m₁, m₂, . . . , mₚ that are best for each of them, and will receive second passwords PW(2) PW(3), . . . , PW(k) that serve to identify the image data converted to be suitable for the printing devices m₁, m₂, . . . , mₚ, (see Step S142 of FIG. 12 to Step S137 of FIG. 11, and Step S143 of FIG. 12). Note that it is assumed that the processes noted here are performed (k−1) times for each user (=dashed lines 2, 3, . . . , k−1 and k). The second passwords PW(2), PW(3), . . . , PW(k) assigned to each user will function as keys for the printing devices m₁, m₂, . . . , mₚ (see both arrows inside the dashed lines 2, 3, . . . , k, and see FIG. 13).

Note that the “terminal device” of the present invention may be capable of sending and receiving e-mail, and thus the “terminal device” of the present invention can use as is any type of technology that is used or capable of being used as e-mail technology. For example, if e-mail address rejection is used, technology that refuses receipt of an e-mail in the server 310, technology that sets the maximum size of an e-mail that can be received, or the like, can be employed in situations in which, for example, the e-mail address is a free e-mail account.

Furthermore, in the aforementioned embodiment, the process of converting the transmitted image information to the image data is performed in the server 310. However, this conversion process also includes a conversion from image information to image data in which any of the print settings are incorporated therein, such as the size of the paper to be used for printing, the use of color printing or monochrome printing, and the like. In this configuration, the server 310 or the printing device 110 must be notified of the print settings. However, like with the methods described above, such as the method in which the user selected the password, or the method in which the user selected the printing device, a method may be adopted in which, for example, the text of the e-mail will be used to perform this notification.

Thus, if image data that incorporates the print settings is produced, it will be extremely convenient for the user because he or she may in substance need only to input the second password into the printing device, and then start printing immediately thereafter.

Handling of the printing device and the password stored in the server

In addition, what occurs after the first password and the image information are received by the server 310 and stored in the storage device 313, or after the second password and image data are received by the printing device 110 and stored in the storage device 112 (e.g., whether these items will continue to be stored there for a long period of time, and the like) has not been particularly mentioned in the aforementioned embodiment, however the following processes may for example be performed in connection therewith. In a first example, if looking at the printing device 110, if a regular second password is input and printing based on the corresponding image data is completed, the second password and the image data may be deleted from the storage device 112.

In a second example, looking at the same printing device 110, the second password and image data may be deleted in situations in which, after the second password and image data are received, a fixed period of time (e.g., three days, one week, etc.) has expired, or in addition to this, the second password has not been input with this time period. By retaining the second passwords and image data that appear to have been left by users for a long period of time, the storage capacity of the storage device 112 may continue to be wastefully used, and thus the aforementioned examples will be convenient for the system administrator and for other users that will use the image forming system. In addition, for a user that appears to have left his or her password and image data, it is not considered desirable that one's own image data be retained in a public printing device for a long period of time, and thus automatically deleting the image data can be desirable from the point of view of protecting the privacy of the user. This can be thought of in the same way as when the first password and the image information are left in the storage device 313 of the server 310 for a fixed period of time (e.g., when an e-mail containing the first password is not sent at all (see Step S133 of FIG. 11)).

Note that as described above, there is no need for the first and second passwords to be complex because it is preferable that the first and second passwords be valid for only a comparatively short period of time. In addition, in the aforementioned embodiment because the first and second passwords are made unique in order to identify the image information in the e-mail containing the image information that a certain user transmitted at a certain time or the image data that was formed based on the image information, and moreover, as noted above, it is preferable that a configuration be adopted in which the so-called used second passwords and image data are completely deleted, the confidentiality of the image information or the image data can be well maintained.

Furthermore, if the configuration is as described above, in situations in which a certain user cannot go to the place where the printing device is located even though he or she is in possession of a second password, the user can tell another person that is near the printing device what the second password is, and have that other person perform the printing instead. Although it is thought to be difficult to maintain confidentiality when the validity of the second password or the image data is effectively managed over a long period of time, and although the second password will be divulged to a third party when the user tells the other person what the password is, confidentiality can be maintained at an even better level in the aforementioned embodiment because it is preferable that the second password be valid for only a comparatively short period of time, and that the second password be valid for only one use.

Supplemental information transmitted in lieu of or in addition to the first or second passwords

In the present embodiment the server 310 may be configured so that in lieu of or in addition to the transmission of the first or second password to each terminal device (Step S1322 or Step S137 of FIG. 11), “predetermined supplemental information” will be to transmitted to each terminal device. Here, predetermined supplemental information can be thought of as a variety of information. In a first example, the server 310 can be configured such that if it is not successful in receiving the e-mail for some reason, or if the reception thereof is rejected, the server 310 will transmit an “error message” in lieu of the issuance and transmission of a first or a second password.

In a second example, the server 310 can be configured such that in addition to the issuance and transmission of the first or second password, a “review screen” in accordance with the print settings (e.g., the size of the paper to be used, whether color printing is to be executed, and the like) desired by the user of the PC 510 will be transmitted.

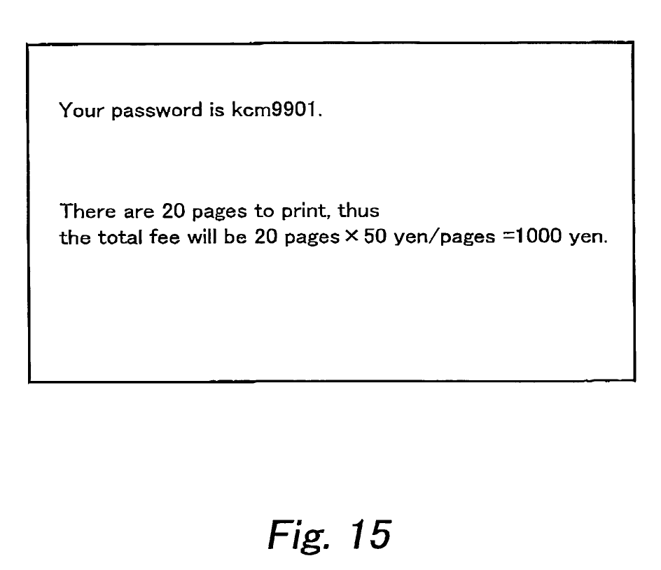

In a third example, a “fee table” can be transmitted in situations in which a “use fee” for printing or various settings and the like have been established. An example of a “use fee” is shown in FIG. 15. Note that the example shown in the figure is at the point (Step S143 of FIG. 12) at which the second password “kcm9901” is received.

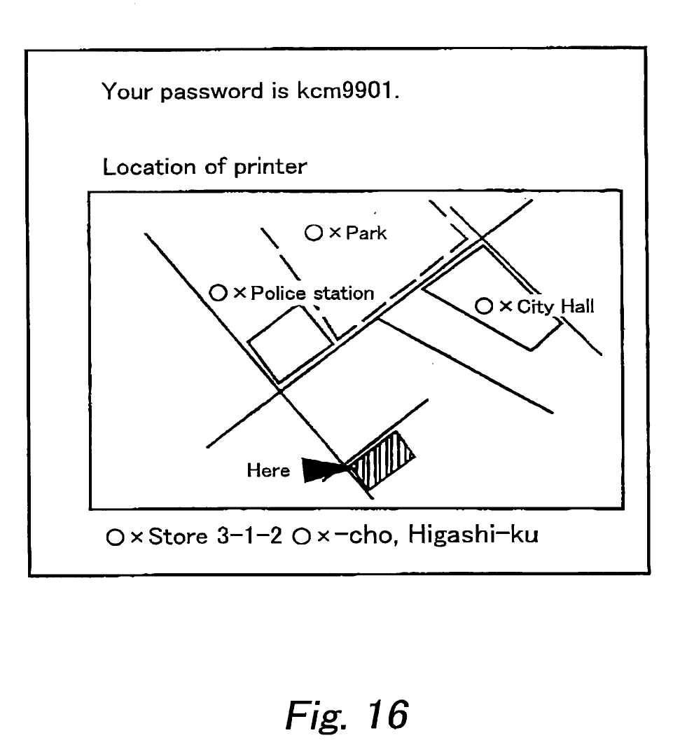

In a fourth example, the server 310 can transmit a “map” showing the location of the store (such as a convenience store) in which the printing device that was specified in the “specification process” referred to in Step S132 of FIG. 11 (i.e, the printing device desired by the user to execute printing) is located, or can transmit the name of the store. An example of this is shown in FIG. 16.

In a fifth example, “predetermined supplemental information” that can generate advertisement fee income from a predetermined sponsor can be transmitted to a user.

In one version of the fifth example, the server 310 can transmit “image data” or “music data” that contains an advertisement for the store in which the printing device desired by a user to execute printing is located, the shopping street on which the store is located, a commercial establishment near the store, or a company that is connected with the management the image forming system (e.g., the company that contracted with the store, hereinafter referred to as the system management partner). Here, the store, the shopping street, the commercial establishment, or the system administration partner can be assumed to be a sponsor. However, “image data” includes images that can be used as wallpaper on the user's terminal device, “music data” includes music samples such as songs and the like, and when the terminal device used by the person transmitting the e-mail is, for example, the portable telephone 410, “music data” can be music to be used as a ring tone. Here, it can be assumed that a sponsor is using the supplemental information to conduct advertising, but the supplemental information can be used by persons or organizations other than a sponsor.

In a second version of the fifth example, a coupon, a complementary ticket, or the like for the store, the shopping street, or the commercial establishment can be transmitted. With this configuration as well, the store or the like can be the sponsor. However, the “discount coupon” can also be for future usage of the image forming system.

As described above, “predetermined supplemental information” can be various types of information, but regardless of the type thereof, if this information is transmitted in lieu of or in addition to the first or second password, it will provide the user with an opportunity to come across beneficial information, and will allow advertisement fee income to be generated.

Note that it is also possible to continually transmit certain “supplemental information”, but in lieu of the supplemental information or in addition thereto, it is also helpful to adopt a configuration which will select supplemental information to transmit in response to the content of the e-mail that was sent, or in response to the user of the terminal device that sent the e-mail. For example, when the “predetermined supplemental information” includes a “preview image”, the significance of specially informing the user that his or her desired printing is normal and has no abnormalities will decline. Thus, depending on the situation, it is also possible to eliminate processes, such as omitting the transmission of the “preview image”.

In addition, if the “predetermined supplemental information” includes image data containing advertising for a store in which the printing device that is to execute the printing desired by the user is located, there will be a heightened need to select the image data to be transmitted in accordance with the store. In this type of situation, a configuration may be adopted in which image data that includes advertisements for all stores in which the printing devices 110-140 are located is stored in the storage device 313 of the server 310, and the optimal image data is selected therefrom. In this configuration, as note above, when the user transmits an e-mail that accompanies the selection of the printing device, the image data to be transmitted may be selected in accordance with the content of the e-mail (i.e., the store where the selected printing device is located). The above meanings are included in the terms “in accordance with the content of the e-mail”, or “in accordance with the user of the data transmission terminal device”.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. An image forming system, comprising:
image forming devices that perform image formation on paper based upon image data;
a plurality of terminal devices that are connected to the image forming devices via connection means, and which can transmit e-mail containing image information to the connection means; and
an administration terminal device that, in response to the receipt of e-mail containing image information via the connection means, transmits a predetermined password that identifies the image information to a data transmission terminal device that transmitted the e-mail and that is one of the plurality of terminal devices.

2. The image forming system set forth in claim 1, wherein the administration terminal device is comprised of a mail server that transmits e-mail containing the image information and transmits the predetermined password, and an application server that issues the predetermined password in accordance with a predetermined procedure.

3. The image forming system set forth in claim 2, wherein the predetermined procedure comprises one in which a user of the data transmission terminal device will select all or a portion of at least one text string and number string that forms a portion of the password.

4. The image forming system set forth in claim 2, wherein the predetermined procedure comprises one in which all or a portion of an e-mail address of the data transmission terminal device will be incorporated into all or a portion of the password.

5. The image forming system set forth in claim 1, wherein the administration terminal device transmits predetermined supplemental information to the data transmission terminal device in lieu of or in addition to the password.

6. The image forming system set forth in claim 5, wherein the administration terminal device comprises:
storage means that stores a plurality of supplemental information which includes the predetermined supplemental information; and
supplemental information selection means that selects the predetermined supplemental information from the plurality of supplemental information stored in the storage means in response to at least one of the content of the e-mail and the user of the data transmission terminal device.

7. The image forming system set forth in claim 1, wherein the image forming devices comprise first to n-th image forming devices, where n is a positive integer; and
the administration terminal device comprises identification means that identifies an m-th image forming device from amongst the first to n-th image forming devices, where m is a positive integer and 1≦m≦n, and transmission means that transmits the password and the image data that was formed based upon the image information to the m-th image forming device.

8. The image forming system set forth in claim 7, wherein each first to n-th image forming device is assigned an e-mail address selected from first to n-th e-mail addresses; and
the identification means identifies the m-th image forming device based upon whether any e-mail address used as an addressee of the e-mail matches any of the first to n-th e-mail addresses.

9. The image forming system set forth in claim 7, wherein the supplemental information selection means selects the predetermined supplemental information from amongst the plurality of supplemental information stored in the storage means in response to where the m-th image forming device identified by the identification means is installed.

10. The image forming system set forth in claim 7, wherein each image forming device comprises image formation device storage means that stores the image data and the password.

11. The image forming system set forth in claim 10, wherein each image forming device further comprises deletion means that deletes at least one of the image data and the password from the image forming device storage means after a fixed period of time.

12. The image forming system set forth in claim 1, wherein the image forming device comprises charging mean that serves to charge a fee to execute image formation.

13. An image forming device that perform image formation on paper based upon image data, the image forming device comprising:
reception means that identifies image information contained in an e-mail transmitted from a terminal device by receiving a predetermined password issued from an a administration terminal device that is an addressee of the e-mail, and image data that is formed based upon the image information; and
control means that will only execute image formation based upon the image data when the password is input.

14. An image forming system, comprising: first to n-th image forming devices that each perform image formation on paper based upon image data, where n is a positive integer;
a plurality of terminal devices that are connected to the image forming devices via connection means, and which can transmit e-mail containing image information to the connection means; and
an administration terminal device that, in response to the receipt of e-mail containing image information via the connection means, its via the connection means a predetermined first password that identifies the image information to at least one of a data transmission terminal device that transmitted the e-mail and that is one of the plurality of terminal devices and selected terminal devices that are selected by a user of the data transmission terminal device via the e-mail; and
the administration terminal device comprises:
identification means that identifies from amongst the 1st to n-th image forming devices an m-th image forming device that will execute image formation based upon the image information, where m is a positive integer and 1≦m≦n, based upon a content of e-mail containing the first password transmitted from a print request terminal device that is used by a user requesting printing and is one of the terminal devices that received the transmission of the first password; and
transmission means that transmits to the m-th image forming device the image data formed based upon the image information that was identified by the first password and a predetermined second password that identifies the image data, and transmits the second password to the print request terminal device.

15. The image forming system set forth in claim 14, wherein each first to n-th image forming device is assigned an e-mail address selected from first to n-th e-mail addresses; and
the identification means identifies the m-th image forming device based upon whether any e-mail address used as an addressee of the e-mail transmitted from the print request terminal device matches any of the first to n-th e-mail addresses.

16. The image forming system set forth in claim 14, wherein the administration terminal device is comprised of a mail server that transmits e-mail containing the image information and transmits the predetermined first and second passwords, and an application server that issues the predetermined first and second passwords in accordance with a predetermined procedure.

17. The image forming system set forth in claim 16, wherein the predetermined procedure comprises one in which a user of the data transmission terminal device or the print request terminal device will select all or a portion of at least one text string and number string that forms a portion of the first or second passwords.

18. The image forming system set forth in claim 16, wherein the predetermined procedure comprises one in which all or a portion of an e-mail address of the data transmission terminal device or the print request terminal device will be incorporated into all or a portion of the first or second passwords.

19. The image forming system set forth in claim 14, wherein the administration terminal device transmits predetermined supplemental information to the data transmission terminal device or the print request terminal device in lieu of or in addition to the first or second passwords.

20. The image forming system set forth in claim 19, wherein the administration terminal device comprises:
storage means that stores a plurality of supplemental information which includes the predetermined supplemental information; and
supplemental information selection means that selects the predetermined supplemental information from the plurality of supplemental information stored in the storage means in response to at least one of the content of the e-mail and the user of the data transmission terminal device or the print request terminal device.

21. The image forming system set forth in claim 19, wherein the supplemental information selection means selects the predetermined supplemental information from amongst the plurality of supplemental information stored in the storage means in response to where the m-th image forming device identified by the identification means is installed.

22. The image forming system set forth in claim 14, wherein each image forming device comprises image formation device storage means that stores the image data and the second password.

23. The image forming system set forth in claim 22, wherein each image forming device further comprises deletion means that deletes at least one of the image data and the second password from the image forming device storage means after a fixed period of time.

24. The image forming system set forth in claim 14, wherein the image forming device comprises charging means that serves to charge a fee to execute image formation.
